(19) United States
(12) Patent Application Publication
(10) Pub. No.: US 2006/0114462 A1
(43) Pub. Date: Jun. 1, 2006

(54) Apparatus and method for measuring wavelength of an optical light

(75) Inventors: Mei-feng Zhou, Hang-Zhou (CN); Chang-fu Yi, Hang-Zhou (CN)

Correspondence Address: TROXELL LAW OFFICE PLLC, SUITE 1404, 5205 LEESBURG PIKE, FALLS CHURCH, VA, 22041, US

(73) Assignee: Asia Optical Co., Inc.

(21) Appl. No.: 11/210,729

(22) Filed: Aug. 25, 2005

(30) Foreign Application Priority Data
Nov. 29, 2004 (TW) 093136787

(51) Int. Cl. G01J 3/46

(52) U.S. Cl. 356/425

(57) ABSTRACT

A measuring-wavelength apparatus includes a beam splitter (2), a first optical sensor (6), a second optical sensor (7), a signal-attenuation component (5) and a processing unit (8). A measuring-wavelength method comprising: splitting an incoming light into a first beam and a second beam; transforming the first beam into a first output signal; attenuating the second beam by using a signal-attenuation component; transforming the attenuated second beam into a second output signal; calculating a difference between the first and the second output signals to achieve an optical loss of the light; and in view of the optical loss, looking up a reference table to obtain a wavelength of the light.

### BACKGROUND OF THE INVENTION

1. Field of the Invention

The present invention relates to a wavelength measurement apparatus and method for measuring wavelength of an optical light, and more particularly to a measuring-wavelength apparatus and method used for a portable optical detecting device.

2. Description of the Prior Art

Conventionally, a measuring-wavelength apparatus like a Michelson interferometer 1100 as shown in FIG. 2 is widely used to measure a wavelength of a light, and mainly comprises a reference light source 1101 for emitting a reference light having a known wavelength λ₀, a fixed lens 1102, a movable lens 1103 movable in parallel with an optical path, a unidirectional lens 1104 located at an angle of 45 degrees with regard to the optical path, a measured-light photo detector 1105, and a reference-light photo detector 1106.

In the Michelson interferometer 1100, a measured light with an unknown wavelength λ is emitted toward a point B of the unidirectional lens 1104. A part of the outgoing light is reflected, at the point B of the unidirectional lens 1104, toward the fixed lens 1102. Then the light is reversely reflected by the fixed lens 1102 to pass through a point A of the unidirectional lens 1104 and is finally incident to the measured-light photo detector 1105. Thereafter the other part of the measured light subsequently passes through the point B of the unidirectional lens 1104 and the moveable lens 1103, and then is reversely reflected by the movable lens 1103, toward the point A of the unidirectional lens 1104, and is finally incident to the measured-light photo detector 1105.

Meanwhile, a part of reference light emitted from the reference light source 1101 is reflected by the point A of the unidirectional lens 1104 toward the fixed lens 1102, and then is reversely reflected by the fixed lens 1102 to pass through the point B of the unidirectional lens 1104, and is finally incident on the reference-light photo detector 1106. The other part of the reference light passes through the point A of the unidirectional lens 1104, then is reversely reflected by the movable lens 1103 toward the unidirectional lens 1104, and reflected by the point B of the unidirectional lens 1104 to be incident to the reference-light photo detector 1106.

On this way, each photo detector 1105, 1106 respectively receives two incident lights, wherein one light passes through the fixed lens 1102 and the other passes through the movable lens 1103, thus generating a differential peak between these light beams.

As shown in FIG. 3, a pitch length P between each two adjacent wave peaks outputted from the measured-light photo detector 1105 corresponds to the wavelength λ of the measured light. As long as the movable lens 1103 is moved along a direction of an arrow labeled in FIG. 2, cycles of differential peaks of output signals, as shown in FIG. 3, from the respective photo detectors, are successively increased. In case the movable lens 1103 is moved for a predetermined distance D, the wavelength λ of the measured light is determined in views of the numbers n0 of differential peaks outputted from the measured-light photo detector 1105, the number n1 of differential peaks outputted from the reference-light photo detector 1106, and the wavelength λ₀ of the reference light, as represented in the following equation:
λ=(n₀/n₁)×λ₀

However, a measurement of the conventional interferometer must rely on accurate movement control of the movable lens 1103, thus resulting in a hard operation, complexity and higher expense of the interferometer.

Hence, an apparatus or method to overcome the above-mentioned drawbacks is extremely required for the users.

### BRIEF SUMMARY OF THE INVENTION

A primary object, therefore, of the present invention is to provide an apparatus and a method for measuring a light wavelength, with adaptation of a simplified structure and better operationality.

To achieve the foregoing object, a measuring-wavelength apparatus in accordance with the present invention, applicable for a portable optical measuring device, comprises a beam splitter, a first optical sensor, a second optical sensor, a signal-attenuation component and a processing unit. Beside, a measuring-wavelength method according to the present invention comprises the following steps of: splitting a measured light into a first beam and a second beam; transforming the first beam into a first output signal; attenuating the second beam by the signal-attenuation component; transforming the attenuated second beam into a second output signal; calculating a difference between the first and the second output signals to achieve an optical loss of the measured light; and according to the optical loss, looking up a reference table established in a relation between each wavelength and the corresponding optical loss to obtain a wavelength of the measured light.

Contrary to the prior art, the measuring-wavelength apparatus and method according to the present invention utilize a processing unit to rapidly perform a digitalized operation of looking up a wavelength corresponding to the optical loss from the prerecorded reference table, whereby the aforementioned object is achieved.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a block diagram showing the configuration of a measuring-wavelength apparatus according to a preferred embodiment of the present invention;

FIG. 2 shows the principle of a known Michelson interferometer; and

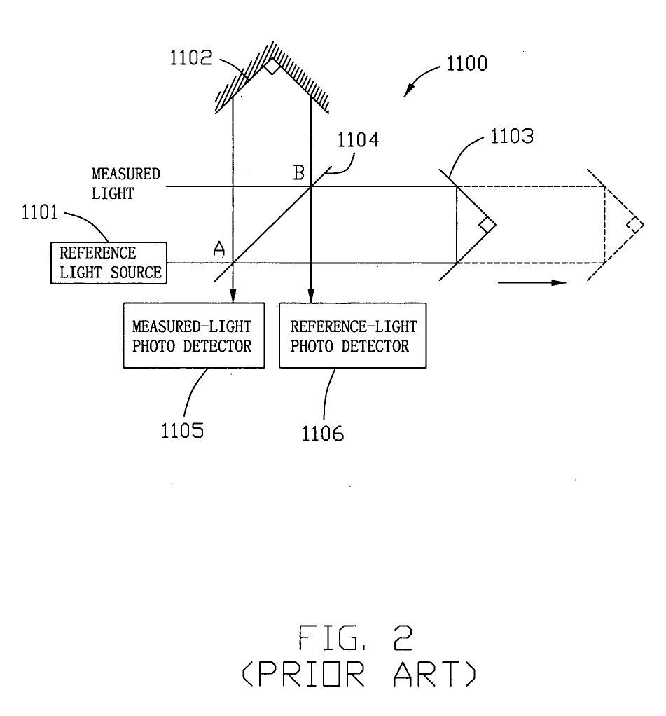

FIG. 3 is a schematic diagram presenting differential peaks generated during operation of the known Michelson interferometer. XXX

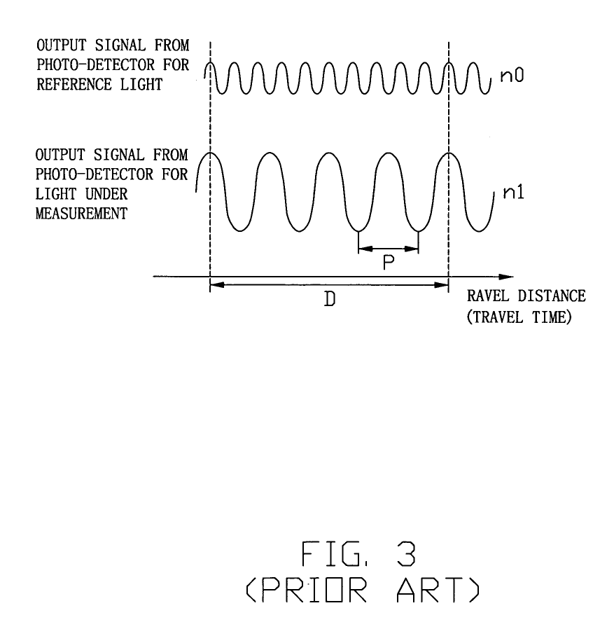

### DETAILED DESCRIPTION OF THE INVENTION

Reference will now be made in detail to the following preferred embodiment of the present invention.

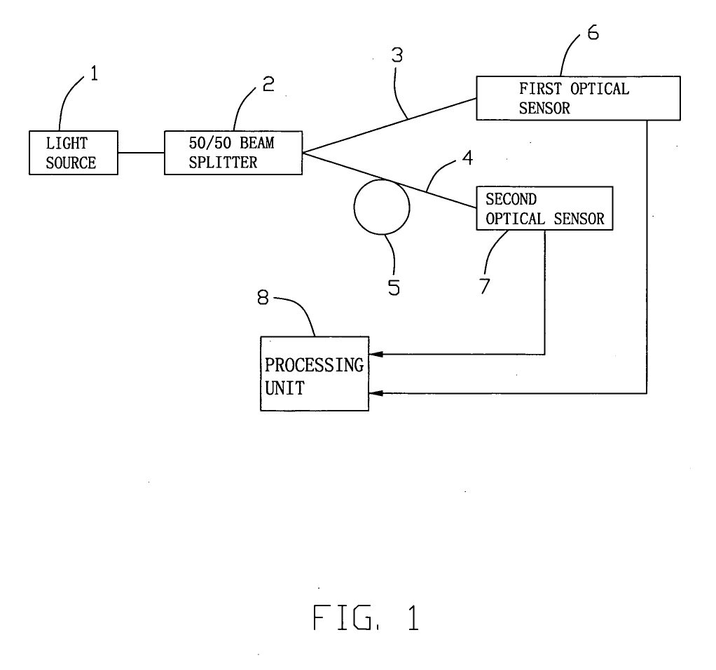

Referring to FIG. 1, a measuring-wavelength apparatus for measuring a light wavelength, in accordance with a preferred embodiment of the present invention, is applicable for a portable optical detecting device such as an optical power meter or an optical losing meter. The measuring-wavelength apparatus has a beam splitter 2, a signal-attenuation component 5, a first optical sensor 6 connected with the beam splitter 2 via a first optical fiber 3, a second optical sensor 7 connected with the beam splitter 2 via a second optical fiber 4, a processing unit 8 like a microprocessor control unit (MCU), and a reference table (not shown) established in a relation between each optical loss and a wavelength corresponding to the optical loss. The lights with different wavelengths broadcasted through the same fiber coil will respectively generate different optical losses. By experiments, a relation between each optical loss and a wavelength corresponding to the optical loss can be built up. A reference table records the relation between each optical loss and the corresponding wavelength and is preset through a memory (now shown) of the processing unit 8. The reference table can be recorded on other kind of medium for convenience of user on looking up.

A light source 1 is provided for emitting a measured light with an unknown wavelength, is connected with the beam splitter 2 via an optical fiber (not labeled). The measured light is broadcasted along a single direction via either the optical fiber, the first or the second optical fibers 3, 4. In the preferred embodiment, the beam splitter 2 is realized as a 50/50 beam splitter which is provided for evenly dividing the measured light into a first beam and a second beam. The first and the second optical sensors 6, 7 may be any kinds of light sensing components, such as an optical diode. The signal-attenuation component 5 is disposed in an optical path between the second beam and between the beam splitter 2 and the second optical sensor 7. The signal-attenuation component 5 can be any kind of component functioning light attenuation and is provided for attenuating the second beam. In the preferred embodiment, the signal-attenuation component 5 is realized with an optical fiber coil made by circularizing a part of the second optical fiber 4. As known in this art, the lights with different wavelengths broadcasted through the same fiber coil will respectively generate different optical losses. The reference table is preset with a memory (now shown) controlled by the processing unit 8, which pre-records each of the said different optical losses and the corresponding wavelengths. The processing unit 8 can be realized as a subtracter for achieving the wavelength of the measured light according to the reference table.

To measure wavelength of an unknown light by using the measuring-wavelength apparatus, a measuring-wavelength method according to the present invention comprises steps as follows. Firstly, the optical light source 1 emits a measured light with an unknown wavelength to the beam splitter 2. Next, the measured light is split into a first beam and a second beam by the beam splitter 2. Thereafter, the first beam is broadcasted to the first optical sensor 6 via the first optical fiber 3. Because an optical path to broadcast the first optical beam from the beam splitter 2 to the first optical sensor 6 is very short, the optical loss of the first beam approaches zero. And, a signal attenuation caused from broadcast of the first beam to the first optical sensor 6 becomes lower. Oppositely, the first optical sensor 6 converts the first beam into a first output signal representing a first-beam power and transmits the first output signal to the processing unit 8. Simultaneously, the second beam is attenuated by the signal-attenuation component 5 and is broadcasted to the second optical sensor 7 via the second optical fiber 4. The second optical sensor 7 converts the second beam into a second output signal representing a second-beam power and emits the second output signal to the processing unit 8. The processing unit 8 receives the first and the second output signals, and accordingly calculates a difference between the first and the second output signals. The difference between the first and the second output signals represents an optical loss L of the measured light. By looking up the reference table, a wavelength corresponding to the optical loss L is found as a wavelength λ of the measured light. It means that the processing unit 8 transforms the optical loss to the wavelength of the measured light by means of using the reference table.

In an exemplar, the first output signal represents an optical power of the measured light before attenuated. The second output signal represents the attenuated optical power of the measured light. If the radius of the optical fiber coil of the signal-attenuation component 5 is 14 mm, the first output signal is generated at −3 dBm and the second output signal is generate at −3.8 dBm. The optical loss of the measured light through the coil is 0.8 dBm. By looking up the reference table, a wavelength 1310 nm corresponding to the optical loss 0.8 dBm is found out as the wavelength λ of the measured light. If the first output signal is −1 dBm and the second output signal is −13 dBm, the optical loss of the measured light is 12 dBm. By looking up the reference table, a wavelength 1550 nm corresponding to the optical loss 12 dBm is found out as the wavelength λ of the measured light.

In conclusion, the measuring-wavelength apparatus and method according to the present invention are capable of digitally measuring an optical loss of an unknown light by the processing unit 8, and further rapidly and automatically achieving a corresponding wavelength in light of said optical loss by looking up the pre-established reference table, thereby making the apparatus configuration simplified, conveniently operated and cost saving. If the optical loss is measured, the user may manually look up the reference table to obtain a wavelength of the measured light.

It is to be understood, however, that even though numerous characteristics and advantages of the present invention have been set forth in the foregoing description, together with details of the structure and function of the invention, the disclosure is illustrative only, and changes may be made in demounting, especially in matters of material, plating method and manufacturing process within the principles of the invention to the full extent indicated by the broad general meaning of the terms in which the appended claims are expressed.

What is claimed is:

1. A measuring-wavelength apparatus comprising:
a beam splitter splitting an incoming light into a first beam and a second beam;
a first optical sensor receiving the first beam from the beam splitter and outputting a first output signal;
a signal-attenuation component receiving and attenuating the second beam;
a second optical sensor receiving the attenuated second beam and outputting a second output signal; and
a processing unit having a reference table which pre-records various optical losses and corresponding wavelengths, in use of calculating a difference between the first and the second output signals to achieve an optical loss of said light, and then transforming the optical loss into the wavelength of the light in view of the reference table.

2. The measuring-wavelength apparatus as claimed in claim 1, wherein the beam splitter is a 50/50 beam splitter for evenly splitting the light into the first and the second beams.

3. The measuring-wavelength apparatus as claimed in claim 1, wherein the first beam is broadcasted without attenuation to the first optical sensor.

4. The measuring-wavelength apparatus as claimed in claim 1 further comprising a first optical fiber for interconnecting the first optical sensor with the beam splitter, whereby the first beam is broadcasted to the first optical sensor through the first optical fiber.

5. The measuring-wavelength apparatus as claimed in claim 1, wherein the signal-attenuation component is disposed in an optical path to broadcast the second beam between the beam splitter and the second optical sensor.

6. The measuring-wavelength apparatus as claimed in claim 5 further comprising a second optical fiber for interconnecting the second optical sensor with the beam splitter.

7. The measuring-wavelength apparatus as claimed in claim 6, wherein the signal-attenuation component is arranged on the second optical fiber.

8. The measuring-wavelength apparatus as claimed in claim 6, wherein the signal-attenuation component is an optical fiber coil made by circularizing a part of the second optical fiber.

9. The measuring-wavelength apparatus as claimed in claim 6, wherein the second beam is broadcasted along a single direction with regard to the second optical fibers.

10. The measuring-wavelength apparatus as claimed in claim 1, wherein the first and the second optical sensors are optical sensors.

11. The measuring-wavelength apparatus as claimed in claim 10, wherein the first output signal represents the optical power of the first beam, and the second output signal represents the optical power of the attenuated second beam.

12. A measuring-wavelength method comprising:
splitting an incoming light into a first beam and a second beam;
transforming the first beam into a first output signal;
attenuating the second beam by using a signal-attenuation component;
transforming the attenuated second beam into a second output signal;
calculating a difference between the first and the second output signals to achieve an optical loss of said light; and
in view of the optical loss, looking up a reference table to obtain a wavelength of the light.

13. The measuring-wavelength method as claimed in claim 12, wherein the light is evenly split into the first and second beams by a beam splitter.

14. The measuring-wavelength method as claimed in claim 13, wherein the first beam is broadcasted without attenuation to a first optical sensor.

15. The measuring-wavelength method as claimed in claim 14, comprising a first optical fiber for interconnecting the first optical sensor with the beam splitter, whereby the first beam is broadcasted to the first optical sensor through the first optical fiber.

16. The measuring-wavelength method as claimed in claim 14, wherein the attenuated second beam is broadcasted to a second optical sensor, whereby the second optical sensor transforms the attenuated second beam into the second output signal.

17. The measuring-wavelength method as claimed in claim 16, wherein the first and the second optical sensors are photo detectors.

18. The measuring-wavelength method as claimed in claim 16, further comprising a second optical fiber interconnecting the second optical sensor with the beam splitter.

19. The measuring-wavelength method as claimed in claim 18, wherein the second beam is broadcasted along a single direction with regard to the second optical fibers.

20. The measuring-wavelength method as claimed in claim 18, wherein the signal-attenuation component is arranged on the second optical fiber.

21. The measuring-wavelength method as claimed in claim 18, wherein the signal-attenuation component is an optical fiber coil made by circularizing a part of the second optical fiber.

22. The measuring-wavelength method as claimed in claim 14, wherein the first output signal represents the optical power of the light before attenuated, and the second output signal represents the attenuated optical power of the light.

23. The measuring-wavelength method as claimed in claim 12, comprising the step of calculating the difference between the first and the second output signals to obtain the optical loss by a processing unit.

24. The measuring-wavelength method as claimed in claim 23, wherein the reference table is pre-established in a memory controlled by the processing unit and records various optical losses and corresponding wavelengths.

25. A measuring-wavelength apparatus comprising:
a beam splitter splitting an incoming light into a first beam and a second beam;
a first optical sensor receiving the first beam from the beam splitter and emitting a first output signal;
a signal-attenuation component receiving and attenuating the second beam;
a second optical sensor receiving the attenuated second beam and emitting a second output signal;
a processing unit receiving the first and the second output signals, calculating a difference between the first and the second output signals to achieve an optical loss of the light; and
a reference table recording various optical losses and corresponding wavelengths.

26. The measuring-wavelength apparatus as claimed in claim 25, wherein the processing unit is realized with a subtracter.

27. The measuring-wavelength apparatus as claimed in claim 26, wherein the reference table can be manually looked up by the user, thereby obtaining the wavelength of the light.
